(19) United States
(12) Patent Application Publication
(10) Pub. No.: US 2019/0043343 A1
(43) Pub. Date: Feb. 7, 2019

(54) PROGRAMMABLE REMOTE CONTROLLER

(71) Applicant: Robolink, Inc., Seoul (KR)

(72) Inventors: Hyunjong Lee, Seoul (KR); Changpyo Hong, Seoul (KR); Hansol Hong, San Diego, CA (US)

(21) Appl. No.: 15/668,202

(22) Filed: Aug. 3, 2017

(51) Int. Cl. G08C 17/02; G08C 23/04

(52) U.S. Cl. CPC G08C 17/02; G08C 2201/92; G08C 2201/20; G08C 23/04

(57) ABSTRACT

A programmable remote controller includes: a controller configured to generate controller signals for controlling a target device; a processor configured to generate a user-programmed sequence based on the controller signals; and a memory configured to store the user-programmed sequence for controlling the target at a later time.

### TECHNICAL FIELD

The disclosed embodiments relate to remote controllers, and, in particular, to user-programmable remote controllers.

### BACKGROUND

Due to technological advancements (e.g., advancements in electrical motors, wireless communications, electrical batteries, processors, memory, etc.), many electronic devices (e.g., drones and robots) have become accessible to consumers (i.e., such as based on reduction in the price for such devices). Often, a remote controller is required to control such devices. While currently available remote controllers can control corresponding devices, they often lack flexibility to expand beyond the factory-programmed capabilities. Further, the available controllers fail to accommodate new paradigms and applications enabled by the increased accessibility.

Thus, there is a need for user-programmable remote controllers. In view of the ever-increasing commercial competitive pressures, along with growing consumer expectations and the desire to differentiate products in the marketplace, it is increasingly desirable that answers to these problems be found. Additionally, the need to reduce costs, improve efficiencies and performance, and meet competitive pressures adds an even greater pressure to find these answers.

### BRIEF DESCRIPTION OF THE DRAWINGS

FIG. 1 is a block diagram illustrating an example of a programmable controller system in accordance with an embodiment of the present technology.

FIG. 2 is a top view of a programmable remote controller in accordance with an embodiment of the present technology.

FIG. 3 is a top view of an internal control circuit in accordance with an embodiment of the present technology.

FIG. 4 is a top view of a further internal circuit in accordance with an embodiment of the present technology.

FIG. 5 is a block diagram illustrating the programmable remote controller in accordance with an embodiment of the present technology.

FIG. 6 is a block diagram illustrating an operational flow of the programmable remote controller in accordance with an embodiment of the present technology.

### DETAILED DESCRIPTION

The technology disclosed herein relates to a controller device (i.e., a programmable remote controller) for operating or controlling one or more target devices (e.g., a drone, a robot, etc.). The controller device can be configured to send to the target device signals or commands corresponding to inputs or stimulus provided by a user. For example, the user can move one or more levers or joysticks on the controller device or press one or more buttons on the controller device to control the target device. The controller device can communicate to the target device the signals or commands that correspond to the manipulation of the levers, joysticks, and/or buttons. Upon receiving and processing the signals or commands, the target device can execute the instructions corresponding to the commands or the signals, such as for physically maneuvering the target device.

In some embodiments, the controller can include aspects or portions that can be configured to control multiple different target devices. The controller can be configurable to match signaling or communication requirements, command or instructions sets, or a combination thereof of multiple devices, such that one controller can be adapted to control target devices of different categories (e.g., manufactured robots, manufactured drones, devices assembled using a kit, etc.) and/or different manufacturers. For example, the programmable controller can include an interface that can accommodate multiple different communication modules (i.e., for utilizing different communication protocols such as Bluetooth, Wi-Fi, Infrared (IR) communication, etc.). Also for example, the programmable controller can include an architecture and/or platform for translating or mapping the various control signals or commands according to various hardware or protocol requirements. As such, the controller can be a ‘universal’ device controller that can be configured to control different target devices instead of being dedicated to controlling only one target device.

In some embodiments, the controller device can further be programmable, such that a user can designate and access a sequence of the controls or signals using the controller device and/or a computing system. For example, the user can manipulate the levers, joysticks, and/or buttons on the controller device to program the sequence of controls or signals. The user can further use programming operations (e.g., ‘if’/‘then’, loops or recursions, data manipulations, etc.) or programming constructs (e.g., objects, toolkits, etc.) along with the manipulation of the controller device to program the sequence and the corresponding actions of the target device. Such user-tailored sequences can be stored on the controller device, the target device, or a combination thereof, which the user can subsequently access and implement through the controller device.

In some embodiments, the programmable controllers can provide further advantages in addition to the adaptability and the user-specific features. For example, the programmable controllers can be used as a tool in teaching and learning computer programming and logical thinking skills. Students can use the programmable controller to program the sequence of actions using controller manipulations familiar to them from their use of other remote controllers. Further, the sequence can be implemented using a maneuverable device (e.g., drones and robots) to provide direct feedbacks to the students.

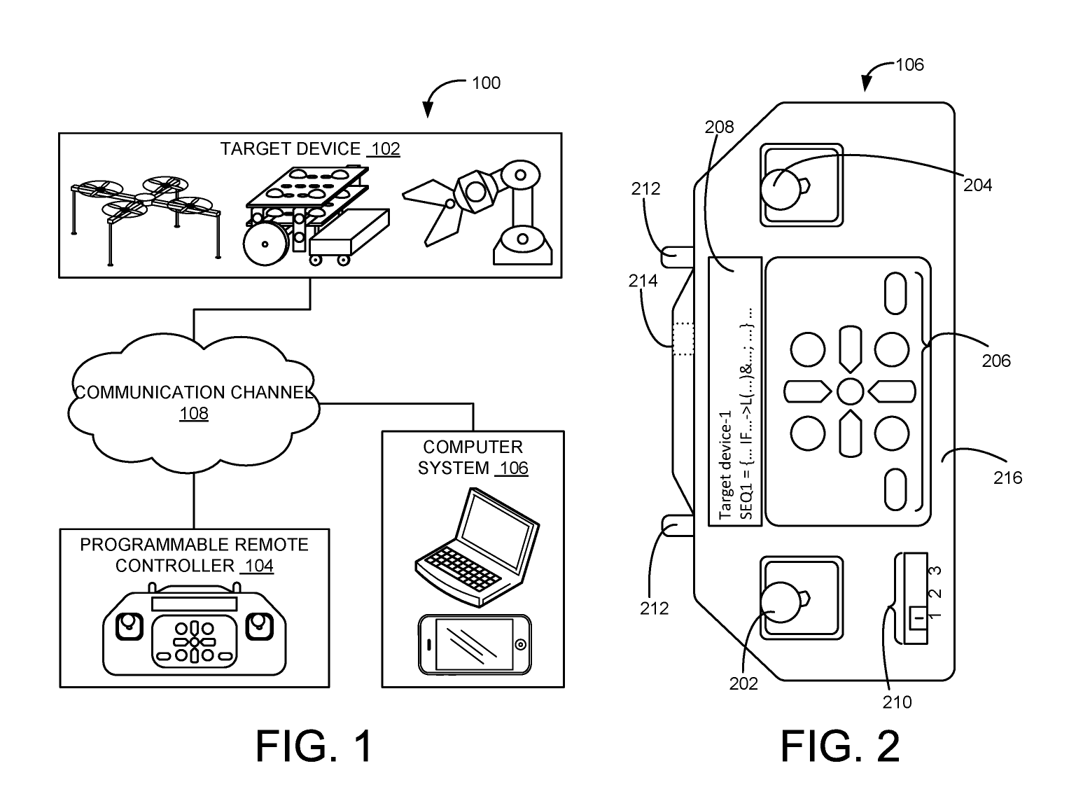

FIG. 1 illustrates an example of a programmable controller system 100 in accordance with an embodiment of the present technology. The programmable controller system 100 can include a target device 102, a programmable remote controller 104, a computer system 106, or a combination thereof.

The target device 102 can include an electronic device that can be controlled or manipulated by a user through a remote controller (i.e., such as using a separate wireless device instead of directly contacting or interfacing with the target device 102). For example, the target device 102 can include devices that can be physically moved or maneuvered, such as a drone, a robot, a user-assembled structure from a kit, etc. Also for example, the target device 102 can include devices that perform other types of functions unrelated to physical displacement.

The user can control the target device 102 through the programmable remote controller 104. The programmable remote controller 104 is a device configured to control functions of a separate device, such as the target device 102. The programmable remote controller 104 can include an interface that the user can utilize to control the target device 102. For example, the programmable remote controller 104 can include a direction button, a joystick, a throttle controller, a lever, or a combination thereof to maneuver the drone or the robot in real-time.

The programmable remote controller 104 can be a configurable device that can adapt to various different types (e.g., a drone, a robot, etc.) or instances (e.g., different models, brands, manufacturers, etc.) of the target device 102. The programmable remote controller 104 can be “universal” without being dedicated or restricted to controlling only one device or type of device. For example, one instance of the programmable remote controller 104 can be configured or adapted to control a drone, and also to control a robot.

In some embodiments, the programmable remote controller 104 can include multiple communication modules (e.g., an IR communication module, a Bluetooth communication module, a communication module designated for a specific frequency or a specific target device, etc.) that can be selected by a user. In some embodiments, the programmable remote controller 104 can include a port or a receptacle that can accommodate different types or instances of the communication modules. In some embodiments, the programmable remote controller 104 can include an architecture, a software driver or tool, a protocol, a circuitry, or a combination thereof that can translate or map control signals to a specific communication protocol or a specific target device.

The programmable remote controller 104 can be configured to allow the user to generate a custom sequence of commands or instructions. The programmable remote controller 104 can include a circuitry, an architecture, a system manager, a mechanism, or a combination thereof for allowing the user to write or generate a computer program that includes the custom sequence of commands or instructions used to control or maneuver the target device 102.

The user can write or generate the computer program using the interface of the programmable remote controller 104, such as a direction button, a joystick, a throttle controller, a lever, etc. The programmable remote controller 104 can further include additional components in the interface for the programming function. For example, the programmable remote controller 104 can include other buttons, keyboard, touchscreen interface, display, or other input mechanism that the user can utilize to input programming constructs (e.g., “if-then,” logical operators such as ‘AND’ or ‘OR,’ repeats or loops, etc.).

In some embodiments, the user can further use the computer system 106 (e.g., a server, a personal computer, a laptop, a smart phone, a wearable device, or a combination thereof) in controlling the target device 102. For example, the computer system 106 can be used to check, update, debug, or evaluate the computer program (i.e., the sequence of controls or instructions intended to control or maneuver the target device 102 upon execution of the program file) generated using the programmable remote controller 104.

The target device 102, the programmable remote controller 104, the computer system 106, or a combination thereof can communicate information (e.g., a command, a status, a file, programming code, etc.) through one or more communication channels 108. The communication channels 108 can include connections, protocols, and other mechanisms that facilitate exchange of information between devices. For example, the communication channel 108 can include a wired connection, such as wiring pairs, networking cables, Universal Serial Bus (USB) connections, etc. Also for example, the communication channel 108 can include wireless connections, such as connections based on a dedicated time window or carrier frequency, cellular communication (e.g., Long-Term Evolution (LTE)), Bluetooth, Wireless Fidelity (Wi-Fi), infrared (IR) communication, Near Field Communication (NFC), etc.

FIG. 2 is a top view of a programmable remote controller 104 in accordance with an embodiment of the present technology. The programmable remote controller 104 can include an interface for allowing the user to control or maneuver the target device 102 in real-time, generate or write a sequence of controls or instructions, adapt or configure the programmable remote controller 104 to a specific target device, or a combination thereof.

For example, the programmable remote controller 104 can include a first movement controller 202, a second movement controller 204, or a combination thereof for controlling or maneuvering the target device 102. The user can manipulate the first movement controller 202, the second movement controller 204 or a combination thereof (e.g., a joystick, a throttle lever, a direction pad, a dial, a trigger, a button, or a combination thereof) to control a physical action or displacement of the target device 102 in real-time. The user can further use the first movement controller 202, the second movement controller 204 or a combination thereof to program a sequence of commands and corresponding movements for execution at a later time.

Also for example, the programmable remote controller 104 can include a programming input interface 206, a user-communication interface 208, or a combination thereof for generating or writing the sequence of controls or instructions. The programming input interface 206 can include a mechanism (e.g., one or more buttons, a key pad, a touch screen interface, etc.) for receiving inputs from the user. The programming input interface 206 can correspond to inputs associated with computer programming constructs, such loops or repeats, recursions, logical or mathematical comparisons, logical or mathematical operators, conditional instructions, jumps or function calls, etc. The user-communication interface 208 can include one or more components (e.g., speakers, display screens, lights, haptic circuitry, etc.) configured to communicate information to the user, such as sounds, texts, or images representing the sequence of the commands, a status or configuration of the programmable remote controller 104, a status or message from another device, etc.

Also for example, the programmable remote controller 104 can include a target selector 210 for selecting the target device 102 or a communication protocol from a set of devices or protocols. The programmable remote controller 104 can include hardware (e.g., one or more communication modules compatible with multiple frequencies, protocols, etc.), software (e.g., multiple drivers dedicated to different protocols), or a combination thereof for communicating with multiple different types or instances of the target devices. The target selector 210 can select one instance of the target device 102 by selecting one communication mechanism (i.e., by selecting a specific driver, protocol, frequency, time slot, etc.).

The programmable remote controller 104 can further include an antenna 212, a communication port 214, or a combination thereof for communicating with other devices. The antenna 212 can be used to transmit and/or receive wireless signals, such as for Bluetooth, cellular communication, Wi-Fi, etc. The communication port 214 can be used to transmit and/or receive signals through a wire or a cable, such as for Ethernet connections, USB connections, etc.

The programmable remote controller 104 can include an outer case 216 used to affix the various components discussed above. The outer case 216 can further encase circuits, electrical or mechanical components, mechanisms, or a combination thereof of the programmable remote controller 104.

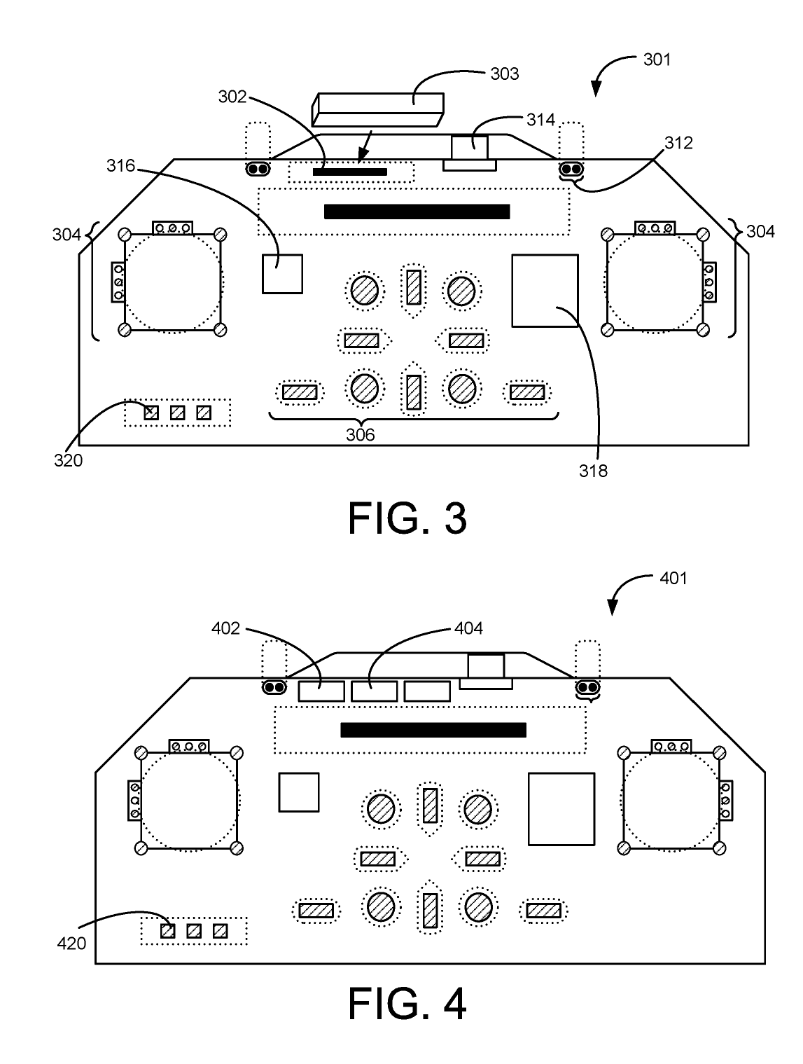

FIG. 3 illustrates a top view of an internal control circuit 301 in accordance with an embodiment of the present technology. The internal control circuit 301 can be contained within the outer case 216 of FIG. 2 and provide the circuitry, the software, the system, the mechanism, or a combination thereof for implementing function of the programmable remote controller 104 of FIG. 1.

In some embodiments, the programmable remote controller 104 can include the internal control circuit 301 that can be user-configured or adapted to control different target devices. For example, the internal control circuit 301 can include one or more wireless module connectors 302, each configured to receive one or more of various different types or instances of removable wireless modules 303 (i.e., hardware circuitry configured to transmit or receive signals according to one or more communication mechanisms, such as Bluetooth, IR, Wi-Fi, proprietary or designated mechanism specifically for a target device, etc.). To adapt the programmable remote controller 104 to control a specific instance of the target device 102 of FIG. 1, the user can attach or connect a specific instance (i.e., the module corresponding to a desired target device) of the removable wireless modules 303 (i.e., the module corresponding to the target device) to the wireless module connector 302 on the internal control circuit 301.

The wireless module connectors 302 include a port, a receptacle, a plug, a pin or a wire, or a combination thereof for receiving and connecting with a specific wireless module or a variety of different wireless modules. For example, the wireless module connectors 302 can be specifically configured to receive a Bluetooth communication module or a Wi-Fi communication module, a communication module for a specific carrier frequency, or a communication module specific to one instance of the target device. Also for example, the wireless module connectors 302 can include a generalized or universal configuration that is capable of receiving one wireless module from a set of compatible modules (e.g., Bluetooth, Wi-Fi, specific carrier frequency, one corresponding to a specific target device, etc.).

The internal control circuit 301 can further include circuits or components corresponding to the interface portion of the programmable remote controller 104, such as illustrated and discussed above for FIG. 2. For example, the internal control circuit 301 can include one or more movement controller circuits 304 that each correspond to a movement controller, such as the first movement controller 202 of FIG. 2 or the second movement controller 204 of FIG. 2. The movement controller circuits 304 can detect a position of the corresponding movement controller for generating and/or communicating a control signal matching the position.

Also for example, the internal control circuit 301 can include one or more programming input circuits 306 that correspond to the programming input interface 206 of FIG. 2. The programming input circuits 306 can include circuitry for detecting a press of a button or a key, a contact between a user's finger and a surface, or a combination thereof. The programming input circuits 306 can include a value (i.e., representing a specific programming construct) for each key, button, or location that is statically and/or permanently assigned during manufacturing or dynamically assigned during operation of the programmable remote controller 104.

Also for example, the internal control circuit 301 can include one or more antenna ports 312, one or more of the antennas 212 of FIG. 2, one or more USB ports 314, or a combination thereof. The antenna ports 312 can each include a port, a receptacle, a plug, a pin or a wire, or a combination thereof for receiving and connecting with the antennas 212 in transmitting and/or receiving wireless signals. The USB ports 314 can include a connector for receiving and connecting with USB devices or cables.

The internal control circuit 301 can further include one or more processors 316 and one or more memory 318 configured to implement one or more functions of the programmable remote controller 104. The one or more processors 316 can include programmable general-purpose or special-purpose microprocessors, programmable controllers, application-specific integrated circuits (ASICs), programming logic devices (PLDs), or the like, or a combination of such devices. The one or more memory 318 can include non-transitory memory, such as random access memory (RAM), read-only memory (ROM), volatile or non-volatile memory, flash memory, magnetic or optical-based storage device, or the like, or a combination of such components. The memory (e.g., the ROM portion) can store computer-executable instructions for operating functions of the programmable remote controller 104 (e.g., the real-time device control, the target device selection or configuration, the programming platform or interface, etc.). The memory (e.g., writable memory such as the flash portion or the RAM portion) can further store user-generated sequence of commands or instructions for controlling or operating the target device 102.

The internal control circuit 301 can further include a selector circuit 320 that corresponds to the target selector 210 of FIG. 2. The selector circuit 320 can allow the user to select one of multiple potential target devices, communication protocols, communication settings, communication mechanisms, or a combination thereof. For example, the programmable remote controller 104 can include a removable wireless module 303 including multiple settings each capable of controlling a different device. The selector circuit 320 can select one of multiple settings corresponding to the set of different devices corresponding to the removable wireless module 303. The selector circuit 320 can select one portion or section within the removable wireless module 303, a specific driver or software package, or a combination thereof to select the one of multiple settings.

The internal control circuit 301 can include other circuits or components not illustrated in FIG. 3. For example, the internal control circuit 301 can include a power subsystem (e.g., a battery or a power connector), wiring, control logic, etc.

FIG. 4 illustrates a top view of a further internal control circuit 401 in accordance with an embodiment of the present technology. In some embodiments, the programmable remote controller 104 can include the further internal control circuit 401 that includes hardware, software, or a combination thereof that can control a set of target devices, where the user can select one configuration out of the set. The further internal control circuit 401 can be preconfigured to implement a set of different communication and/or control schemes. For example, the further internal control circuit 401 can include multiple wireless modules, such as a first module 402 (i.e., a circuitry configured to implement a specific communication mechanism, such as Bluetooth or device specific mechanism, for controlling an instance or a type of target device) and a second module 404 (i.e., a different circuitry configured to implement a different communication mechanism for controlling a different instance or type of target device), configured to communicate with and/or control different devices.

The further internal control circuit 401 can further include a selector circuit 420 configured to select one of the multiple wireless modules (e.g., for selecting the first module 402 or the second module 404 for controlling a device corresponding thereto). For example, the further internal control circuit 401 can include selection positions or input choices corresponding to each of the multiple wireless modules. The programmable remote controller 104 can utilize the wireless module corresponding to the user's selection on the further internal control circuit 401, along with any corresponding drivers, software package, etc., to control the corresponding target device.

The further internal control circuit 401 can also include other circuits, components, etc. For example, the further internal control circuit 401 can include one or more movement control circuits, programming input circuits, antenna ports, USB ports, processors, memory, etc.

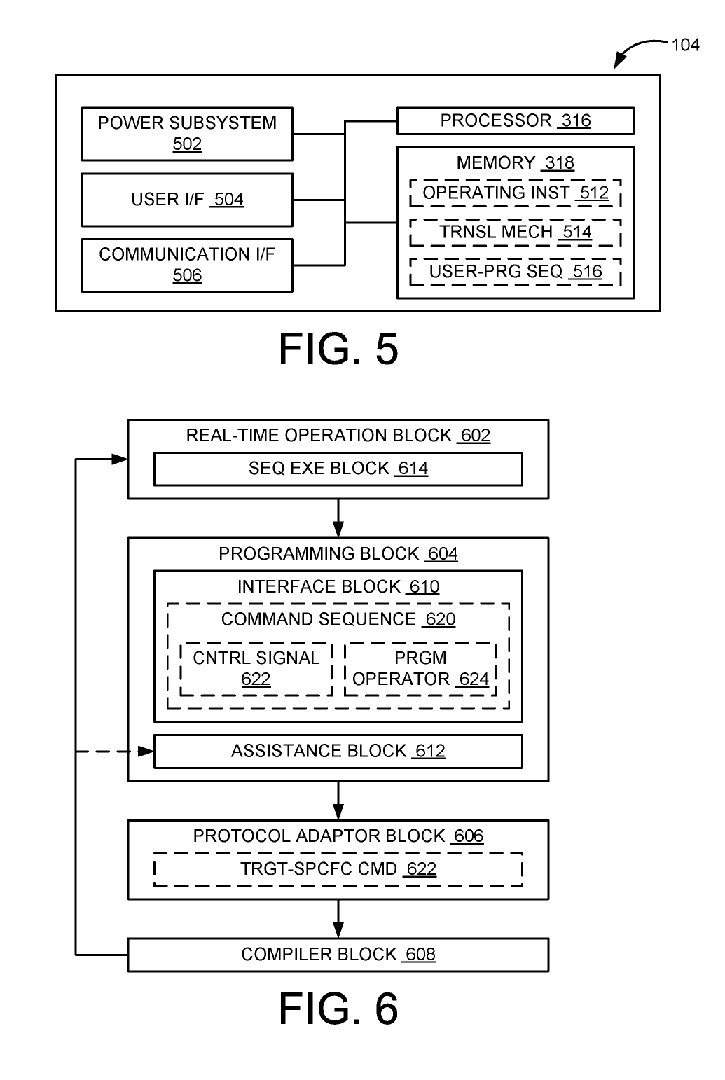

FIG. 5 is a block diagram illustrating the programmable remote controller 104 in accordance with an embodiment of the present technology. The programmable remote controller 104 can include a power subsystem 502, a user interface 504, a communication interface 506, or a combination thereof. The power subsystem 502 can include a power source (e.g., a battery, a power connector, etc.), a charging system, a connector, a wire, or a combination thereof for providing energy for operating the programmable remote controller 104. The user interface 504 can include circuitry or components for communicating with the user, such as the movement controller 202 and/or 204 of FIG. 2, the programming input interface 206 of FIG. 2, the user-communication interface 208 of FIG. 2, the target selector 210 of FIG. 2, or a combination thereof. The communication interface 506 can include circuitry or components for communicating with the target device 102 of FIG. 1, such as the antenna 212 of FIG. 2, the communication port 214 of FIG. 2, one or more communication modules, or a combination thereof.

The programmable remote controller 104 can further include the processor 316 and the memory 318 for implementing one or more functions. The memory 318 can include an operating instruction set 512, a translation mechanism 514, a user-programmed sequence 516, or a combination thereof.

The operating instruction set 512 includes instructions or configuration for operating the programmable remote controller 104. The operating instruction set 512 (e.g., an operating system, a hardware configuration, etc.) includes instructions for implementing real-time control of the target device 102 and instructions for implementing the user-programming platform.

The translation mechanism 514 is a set of instructions, information, or configuration representing a mapping of instructions or commands between the programmable remote controller 104 and the target device 102. The translation mechanism 514 can map a signal or a command generated by the programmable remote controller 104 (e.g., the movement controllers) to a signal or command utilized by the target device 102 (i.e., such as for controlling a movement or a status). For example, the translation mechanism 514 can include a software driver, a hardware circuitry, firmware, or a combination thereof.

The translation mechanism 514 can further implement a communication configuration for facilitating the exchange of data between the programmable remote controller 104 and the target device 102. For example, the translation mechanism 514 can implement a specific communication protocol, such as Bluetooth or Wi-Fi. Also for example, the translation mechanism 514 can select or implement a carrier frequency, a communication code or key, etc. specifically corresponding to the target device 102.

The user-programmed sequence 516 is a user-generated ordering of instructions for commanding the target device 102. The user can use the programmable remote controller 104 to create a custom sequence of commands, movements, conditions, or a combination thereof for controlling the target device 102. For example, the user can use the movement controller to generate the sequence without or instead of controlling the target device in real-time. The generated user-programmed sequence 516 can be stored in the memory 318 of the programmable remote controller 104, and can be recalled and utilized at a later time.

As an illustrative example, the user can program the user-programmed sequence 516 to perform a specific landing sequence or a custom maneuver for a drone, which can be executed or implemented based on recalling or initiating the custom sequence. Also as an illustrative example, the user can program the user-programmed sequence 516 for a robot to find, recognize, and/or pick up a particular object.

FIG. 6 is a block diagram illustrating an operational flow of the programmable remote controller in accordance with an embodiment of the present technology. The operational flow of the programmable controller system 100 of FIG. 1 or the programmable remote controller 104 of FIG. 1 therein can include a real-time operating block 602, a programming block 604, a protocol adaptor block 606, a build block 608, or a combination thereof.

At the real-time operating block 602, the programmable remote controller 104 can control the target device 102 of FIG. 1 in real-time. The user can manipulate the first movement controller 202 of FIG. 2, the second movement controller 204 of FIG. 2, or a combination thereof to control a physical movement or displacement, a status, or a combination thereof of the target device 102. For example, the programmable remote controller 104 can send to the target device 102 signals or commands corresponding to the user's inputs or manipulation of the one or more controllers. Upon receiving the signals or commands, the target device 102 can implement or perform the corresponding movements or displacements, set or control the corresponding status or setting, or a combination thereof.

At the programming block 604, the programmable remote controller 104 can implement the user-programming platform and generate the user-programmed sequence 516 of FIG. 5. The programmable remote controller 104 can directly interface with the user in generating the user-programmed sequence 516, such as represented by an interface block 610.

The programmable remote controller 104 can generate controller signals 622 corresponding to user manipulation of or input through one or more movement controllers (e.g., movement controller 202 and/or the second movement controller 204). For example, the programmable remote controller 104 can generate the controller signals 622 corresponding to ‘up,’ ‘down,’ ‘left,’ ‘right,’ ‘forward,’ ‘backward,’ ‘increase,’ ‘decrease,’ or a combination thereof associated with a movement or a position of one or more movement controllers, any buttons or selectors, or a combination thereof. For the user-programming platform, the controller signals 622 can be used to generate the user-programmed sequence 516 without or instead of controlling the target device 102 in real-time.

The user may also use the programming input interface 206 of FIG. 2 to input programming operators 624 (i.e., representation of programming constructs or operators) in generating the user-programmed sequence 516. For example, the programmable remote controller 104 can generate the programming operators 624 representing loops or repeats, recursions, logical or mathematical comparisons, logical or mathematical operators (e.g., ‘AND,’ ‘OR,’ ‘IF,’ and ‘THEN,’ ‘XOR,’ etc.), conditional instructions, jumps or function calls, etc.

The processor 316 of FIG. 3 can receive the controller signals 622, the programming operators 624, or a combination thereof. The processor 316 can combine the programming operators 624 with the corresponding controller signals 622. The processor 316 can arrange or record the controller signals 622, the programming operators 624, or a combination thereof in a sequence designated by the user. The processor 316 can generate a command sequence 620 to include the controller signals 622, the programming operators 624, or a combination thereof according the user-designated sequence. The memory 318 of FIG. 3 can store the command sequence 620 for further processing.

At a block 612, the user can utilize features associated with generating the user-programmed sequence 516. The user can utilize the computer system 106 of FIG. 1 along with the programmable remote controller 104 to utilize the features associated with generating the user-programmed sequence 516. The computer system 106 can receive the command sequence 620 and/or the user-programmed sequence 516 (i.e., as represented by a loop-back from the build block 608) from the programmable remote controller 104, such as communicated through the antenna 212 of FIG. 2 or the communication port 214 of FIG. 2. The computer system 106 can display the received information on a display and further analyze the received information. For example, the computer system 106 can be used to debug or check the syntax for the command sequence 620 (e.g., computer programming code corresponding to the controller signals 622, the programming operators 624, or a combination thereof).

At the protocol adaptor block 606, the programmable controller system 100 or the programmable remote controller 104 can translate the user's inputs into target-specific commands 626 (i.e., machine-implemented instructions for commanding the target device 102). For translating the user's inputs, the programmable controller 104 can access the translation mechanism 514 of FIG. 5 (i.e., representing a mapping between the controller signals 622 and the target-specific commands 626 for the corresponding target device 102) stored in the memory 318.

In some embodiments, the programmable controller 104 can receive the translation mechanism 514 from the computer system 106 or a server, such as through the antenna 212 or the communication port 214. For example, the user can access a website or a server to download the translation mechanism 514 that corresponds to the removable wireless module 303 of FIG. 3. Also for example, the programmable controller 104 can identify the removable wireless module 303, such as when the user adds a new module to the programmable controller 104, and automatically interact with the computer system 106 and/or a predetermined server to download the translation mechanism 514 corresponding to the removable wireless module 303. In some embodiments, the programmable controller 104 can have one or more instances of the translation mechanism 514 preloaded on the memory 318, with each translation mechanism corresponding to one of the wireless modules (e.g., the first module 402 of FIG. 4 or the second module 404 of FIG. 4) included in the programmable controller 104.

The programmable controller 104 can use the translation mechanism 514 to generate the target-specific commands 626 from the command sequence 620 or the controller signals 622 therein. The processor 316 of the programmable controller 104 can determine the translation mechanism 514 corresponding to the setting of the target selector 210 of FIG. 2 and/or the corresponding wireless module. The processor 316 can also determine the translation mechanism 514 that corresponds to the removable wireless module 303 included in the programmable controller 104.

According to the determination, the processor 316 can generate the target-specific commands 626 based on translating the controller signals 622 (i.e., such as included in the command sequence 620) using the translation mechanism 514. The processor 316 can generate the target-specific commands 626 matching the controller signals 622 according to the translation mechanism 514.

At the build block 608, the programmable controller system 100 or the programmable remote controller 104 can generate the user-programmed sequence 516 corresponding to the controller signal 622. The processor 316 can generate the user-programmed sequence 516 including the target-specific commands 622 sequenced according to the controller signals 622, the programming operators 624, or a combination thereof. For example, the processor 316 can generate the user-programmed sequence 516 by compiling the code and building an executable file.

After generating the user-programmed sequence 516, the sequence can be used to control the target device 102 during real-time control, such as represented in the block 602. At a sequence execution block 614, the programmable controller system 100 can implement the user-programmed sequence 516 and control the target device 102 accordingly. For example, the wireless communication module (e.g., the removable wireless module 303, the first module 402, the second module 404, etc.) can transmit the target-specific commands 622 of the user-programmed sequence 516 to the target device 102 according to the sequence and/or conditions thereof.

In some embodiment, the user-programmed sequence 516 can be executed at the programmable remote controller 104. During real-time operation, the processor 316 can initiate execution of the user-programmed sequence 516 and transmit the target-specific commands 626 of the user-programmed sequence 516 through the wireless communication module.

In some embodiments, the user-programmed sequence 516 can be executed at the target device 102. Before real-time operation, the programmable remote controller 104 can transmit the user-programmed sequence 516 (i.e., including the target-specific commands 626) to the target device 102 for execution at the target device 102 at a later time. During real-time operation, the programmable remote controller 104 can transmit a trigger signal to the target device 102 to initiate execution of the user-programmed sequence 516. Based on receiving the trigger signal, the target device 102 can execute the downloaded user-programmed sequence 516.

The user-programmable remote controller 104 enables the users to create their own maneuvers or functions for the target device 102, thereby providing increased functionalities to the user. The user-programmable remote controller 104 can use the programming platform that can utilize the movement-related inputs of the controller and programming constructs and build the executable file corresponding to the user-tailored maneuvers or functions.

Such programmability can further increase effectiveness in teaching computer programming skills. In a learning environment, providing direct feedback and showing results of the programming efforts through moving gadgets can reinforce concepts and maintain the learner's interest, especially for younger learners. Further, by generating the user-programmed sequence using the controller inputs, learners can quickly learn the programming concepts, operators, and constructs, without having to learn detailed syntax or formats of the programming language. Such use of familiar operations can further help maintain the learner's interest, without requiring the learner to deal with simple texts and formal syntax.

Moreover, the programmable remote further provides adaptable functionalities that can be used in conjunction with robotic kits. A user can build a numerous different structures using such kits, and as such, corresponding controllers should be able to accommodate the vast number of possible movements, functions, and operations. The programmable remote can provide the user with the ability to create the user-tailored functions and maneuvers specific to the unique structure.

Further, the programmable remote provides increased flexibility for the user. With the wireless module connector and the use of the translation mechanism, the programmable remote controller allows the user to adapt the programmable remote controller to control different devices. As such, the user would need only one controller and multiple communication modules, as opposed to multiple controllers, which can reduce costs to the user and the storage space.

Any one of the foregoing components or devices described above with reference to FIGS. 1-6 can be incorporated into any of a myriad of larger and/or more complex systems. Accordingly, the larger/complex systems can include, without limitation, hand-held devices (e.g., mobile phones, tablets, digital readers, and digital audio players), computers, electric vehicles (e.g., electric or hybrid cars, electrically powered boats, etc.), other input devices, etc.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the above descriptions, numerous specific details are given to provide a thorough understanding of the invention. However, it will be apparent that the invention may be practiced without these specific details. In order to avoid obscuring an embodiment of the present invention, some well-known circuits or components, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

I/We claim:

1. A programmable remote controller, comprising:
a controller configured to generate controller signals, wherein the controller signals are for controlling a target device;
a processor, coupled to the controller, configured to generate a user-programmed sequence based on the controller signals from the controller; and
a memory, coupled to the processor, configured to store the user-programmed sequence for controlling the target device at a later time.

2. The programmable remote controller of claim 1, further comprising a wireless module connector, coupled to the processor, configured to receive a removable wireless module, wherein the removable wireless module is for communicating with the target device.

3. The programmable remote controller of claim 2, wherein:
the wireless module connector is configured to receive the removable wireless module, wherein the removable wireless module is circuitry for implementing a Bluetooth communication mechanism, a Wi-Fi communication mechanism, an infrared communication mechanism, a specific communication mechanism corresponding to the target device, or a combination thereof; and
the processor is configured to receive a translation mechanism corresponding to the removable wireless module, wherein the translation mechanism is configured to generate target-specific commands based on translating the controller signals.

4. The programmable remote controller of claim 1, further comprising:
a first communication module, coupled to the processor, configured to implement a communication mechanism for controlling a remote device, wherein the first communication module is hardware circuitry;
a second communication module, coupled to the processor, configured to implement a further communication mechanism for controlling a further remote device, wherein the second communication module is further hardware circuitry; and
a selection circuit, coupled to the first communication module and the second communication module, configured to select the first communication module or the second communication module for controlling the remote device or the further device, respectively.

5. The programmable remote controller of claim 1, further comprising:
a programming input interface, coupled to the processor, configured to generate programming operators representing computer programming constructs associated with the controller signals; and
wherein:
the processor is configured to generate the user-programmed sequence based on combining the programming operators with the controller signals.

6. The programmable remote controller of claim 1, wherein the processor is configured to generate the user-programmed sequence based on:
receiving the controller signals from the controller;
generating target-specific commands matching the controller signals, wherein the target-specific commands represent commands for controlling the target device; and
generating the user-programmed sequence including the target-specific commands sequenced according to the controller signals.

7. The programmable remote controller of claim 6, further comprising a wireless communication module, coupled to the processor, configured to transmit the target-specific commands to the target device.

8. The programmable remote controller of claim 7, wherein:
the processor is configured to initiate execution of the user-programmed sequence; and
the wireless communication module is configured to transmit the target-specific commands of the user-programmed sequence according to the processor.

9. The programmable remote controller of claim 7, wherein the wireless communication module is configured to:
transmit the user-programmed sequence including the target-specific commands to the target device for execution at the target device; and
transmit a trigger signal to the target device, wherein the trigger signal is configured to initiate execution of the user-programmed sequence.

10. The programmable remote controller of claim 7, wherein:
the memory is configured to store a translation mechanism, wherein the translation mechanism represents a mapping between the controller signals and the target-specific commands of the corresponding target device; and
the processor is configured to generate the target-specific commands based on translating the controller signals using the translation mechanism.

11. The programmable remote controller of claim 1, wherein the controller is configured to control physical movement of the target device.

12. The programmable remote controller of claim 11, wherein the target device is one of a drone, a robot, or an assembled structure corresponding to a kit.

13. A programmable controller system, comprising:
a programmable remote controller including:
a controller configured to generate controller signals for controlling a target device, and
a processor configured to generate a user-programmed sequence based on controller signals from the controller; and
a computer system, coupled to the programmable remote controller, configured to communicate with the programmable remote controller.

14. The programmable controller system of claim 13, further comprising the target device, coupled to the programmable remote controller, configured to physically move according to the user-programmed sequence.

15. The programmable controller system of claim 13, wherein the processor of the programmable remote controller is further configured to receive a translation mechanism from the computer system, wherein the translation mechanism represents a mapping between the controller signals and target-specific commands for the corresponding target device.

16. The programmable controller system of claim 13 wherein the computer system is further configured to:
receive the controller signals from the programmable remote controller; and
display the controller signals on a display.

17. The programmable controller system of claim 13 wherein the computer system is further configured to analyze the user-programmed sequence.

18. A method of operating a programmable remote controller for controlling a target device, the method comprising:
receiving controller signals from a controller of the remote controller, wherein the controller is for controlling a physical displacement of the target device in real-time;
at the programmable remote controller, generating a user-programmed sequence based on the controller signals from the controller; and
at the programmable remote controller, storing the user-programmed sequence for controlling the target device at a later time.

19. The method of claim 18 wherein generating the user-programmed sequence includes:
determining a translation mechanism corresponding to the target device, wherein the translation mechanism is for translating the controller signals into commands executable on the target device;
generating target-specific commands matching the controller signals, wherein the target-specific commands represent the commands executable on the target device; and
generating the user-programmed sequence based on sequencing the target-specific commands according to the controller signals.

20. The method of claim 19, wherein determining the translation mechanism includes accessing the translation mechanism corresponding to a removable wireless module within the programmable remote controller.
